(19) United States
(12) Patent Application Publication
(10) Pub. No.: US 2008/0278026 A1
(43) Pub. Date: Nov. 13, 2008

(54) Graphite Brush, and a Motor With Graphite Brush

(75) Inventor: Hiroshi Kobayashi, Aichi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: AISIN SEIKI KABUSHIKI KAISHA, Kariya-shi, Aichi (JP)

(21) Appl. No.: 11/547,505

(22) PCT Filed: Apr. 2, 2004
(86) PCT No.: PCT/JP2004/004879

§ 371 Date: Oct. 12, 2007

(51) Int. Cl. H01R 39/26

(52) U.S. Cl. 310/253

(57) ABSTRACT

To provide a graphite brush (1) that does not wear easily but has an extended longevity regardless of its operating temperature, and a motor with such graphite brush (1). The graphite brush (1), for supplying electricity to a coil (17) wound around a core (9) provided for a rotor (2) of the motor (10), is formed of sintered compact having porosities at a surface of and inside the sintered compact. The porosities are infiltrated with a liquid having a higher boiling point than that of water.

### TECHNICAL FIELD

The present invention relates to a graphite brush for supplying electricity to a rotor of a motor, and more particularly to a graphite brush devised for an extended longevity wherein the graphite brush does not wear easily even if the operating temperature of the graphite brush reaches a high temperature of 100° C. or higher, for example, and to a motor with a graphite brush.

### BACKGROUND ART

In a motor with brushes, the brushes are in sliding contact with a commutator to supply electricity. The commutator has a coil, connected thereto, wound on a core attached to a rotor. When electricity is supplied to the coil, the rotor is rotated by the attractive and repulsive forces applied by the permanent magnets facing the rotor inside a housing.

The motor having the above construction, with the brushes and the commutator being in sliding contact while the motor is in operation, has a problem that wear occurs on slidable contacting surfaces. In order to reduce wear of the brushes while the motor is in operation, research has heretofore been made to reduce electric/mechanical wear of the brushes or spark discharge occurring on the slidable contacting surfaces of the brushes while the motor is in operation by changing the quality of the material of the brushes or adjusting the hardness of the brushes.

On the other hand, where a motor with brushes is used for a vehicle, known graphite brushes for the motor are manufactured by mixing graphite particles and copper particles, using a binder solvent, and then sintering the mixture (see Japanese Unexamined Patent Publication No. 2001-298913 (page 1), for example).

As one example of methods of manufacturing a graphite brush, it is known to mix natural graphite particles as the base material and dissolved phenol resin solution as the binder, add molybdenum disulfide as a solid lubricant, and sinter the mixture at 700 to 800° C. in a nitrogen rich atmosphere. In this case, the dissolved phenol resin formed as a coating film on the surfaces of the graphite particles carbonizes through the sintering and becomes amorphous carbon. The amorphous carbon serves as a binder to combine the graphite particles. Since this sintering sublimates the organic substances of the dissolved phenol resin solution as carbon dioxide and water vapor, numerous porosities are formed both at the surfaces and in the interior of the graphite brush. The graphite brush produced by the above process can take into the porosities the moisture present in the atmosphere owing to the hygroscopic property of the graphite particles forming the brush.

When such graphite brushes are attached to a motor, operation of the graphite brushes will raise the temperature of the slidable contacting surfaces between the graphite brushes and the commutator. Then, moisture vaporizes from internal porosities near the slidable contacting surfaces of the graphite brushes. Wear of the graphite brush can be reduced by what is called vapor lubrication effect where the coefficient of sliding friction is reduced by the water vapor resulting from the vaporization and present between the slidable contacting surfaces of the graphite brushes and the commutator.

When the above motor with the graphite brushes is applied to a vehicle, the sidable contacting surfaces of the graphite brushes and the commutator may reach a high temperature of 100° C. or higher, for example, under the influence of heat generated by the engine in the engine room of the vehicle. In this case, the moisture taken into the porosities of the graphite brushes vaporizes at a significantly higher rate than the rate at a normal temperature. The motor then operates in a state where there is no water vapor between the slidable contacting surfaces of the graphite brushes and the commutator. Consequently, the coefficient of sliding friction of the slidable contacting surfaces becomes large, promoting wear of the graphite brushes.

Therefore, when the conventional graphite brush described above is used under a high temperature condition, the amount of wear per unit operation time increases compared with the usage in a normal temperature condition. As a result, there is a problem that the longevity of the motor with the brushes is reduced.

The present invention has been made having regard to the above problem, and its object is to provide a graphite brush that does not wear easily but has an extended longevity regardless of its operating temperature, and to provide a motor with such graphite brush.

### DISCLOSURE OF THE INVENTION

A first characteristic construction of a graphite brush in accordance with the present invention is that, in a graphite brush (1) for supplying electricity to a coil (17) wound around a core (9) provided to a rotor (2) of a motor (10), the graphite brush (1) is made of sintered compact (22) having porosities (19) at a surface of and inside the sintered compact, said porosities (19) being infiltrated with a liquid (21) having a higher boiling point than the boiling point of water.

With this construction, even when the operating temperature of the motor reaches 100° C. or higher, the liquid in the porosities of the graphite brush does not vaporize completely. The vapor of the liquid present between the slidable contacting surfaces of the graphite brush and the commutator does not disappear. Thus, the coefficient of sliding friction of the slidable contacting surfaces of the graphite brush can be reduced and the amount of wear of the graphite brush can be reduced in comparison with the amount of wear that would occur in the case of a conventional graphite brush.

A second characteristic construction of the graphite brush in accordance with the present invention is that said liquid (21) comprises a mixture of plural kinds of liquids having different boiling points.

With this construction, the liquid in the porosities of the graphite brush vaporizes at different temperatures. Thus, even when the motor is operated over a wide temperature range, the vapor generated from the liquid can be provided between the slidable contacting surfaces of the graphite brush and the commutator, thereby reducing abrasive wear of the graphite brush even when the graphite brush is utilized over a wide range of temperatures.

A third characteristic construction of the graphite brush in accordance with the present invention is that said liquid (21) comprises at least one kind of liquid selected from water-soluble glycols, water-soluble glycol ethers, and glycerin.

This construction provides excellent thermal stability. Even when the operating temperature of the motor is high, vaporization can take place at a predetermined temperature without thermal decomposition. Further, water in the liquid can be used as a liquid that vaporizes in a low temperature region up to 80° C. Where a mixture of plural kinds of liquids is used, a uniform mixture can be obtained since each dissolves smoothly with one another.

A fourth characteristic construction of the graphite brush in accordance with the present invention is that said liquid (21) comprises at least one kind of liquid selected from water-soluble glycols having hygroscopic properties, and water-soluble glycol ethers having hygroscopic properties.

With this construction, moisture in the atmosphere can be taken into said liquid (21), infiltrated in the porosities of the graphite brush. It is therefore unnecessary to infiltrate water into the porosities of the graphite brush beforehand.

A fifth characteristic construction of the graphite brush in accordance with the present invention is that said liquid (21) comprises at least one kind of liquid having a boiling point higher than a maximum temperature of slidable contacting surfaces of said graphite brush (1) and a commutator (8) forming part of said motor (10).

With this construction, the liquid does not boil at any operating temperature of the motor. Thus, the amount of liquid does not decrease sharply, thereby allowing a long time of use.

A sixth characteristic construction of the graphite brush in accordance with the present invention is that said mixture has a greater mixing ratio for said liquid having a lower boiling point.

With this construction, when plural kinds of liquids are mixed, a liquid having a lower boiling point is mixed at the larger ratio since the brush is generally used more frequently at lower operating temperatures. It is thus possible to adapt the graphite brush to the frequency of usage in its temperature range in which the brush is used.

A characteristic construction of a motor having graphite brushes in accordance with the present invention is that a motor (10) comprises: a housing (7) (13); magnets (11) arranged in the housing (7) (13); a rotor (2) rotatably provided in the housing (7)(13) so as to face the magnets (11), and having a coil (17) wounded around a core (9) of the rotor (2); a shaft (4) for supporting the rotor (2) to said housings (7) (13); a commutator (8) provided on said rotor (2) for supplying electricity to said coil (17); and a graphite brush (1) in sliding contact with the commutator (8); wherein said graphite brush (1) is made of sintered compact (22) having porosities (19) at a surface of and inside of the sintered compact, said porosities (19) being infiltrated with a liquid (21) having a higher boiling point than the boiling point of water.

With this construction, even when the motor is utilized in conditions where the temperature reaches 100° C. or higher, the liquid that has infiltrated the porosities of the graphite brush does not completely vaporize, and vapor from the liquid does not disappear between the slidable contacting surfaces of the graphite brush and the commutator. Therefore, the coefficient of sliding friction between the slidable contacting surfaces of the graphite brush and the commutator can be lowered, and the amount of wear of the graphite brush can be reduced. As a result of this, the longevity of a motor having the graphite brush can be increased.

### BRIEF DESCRIPTION OF THE DRAWINGS

FIG. 1 is a sectional view showing a motor using graphite brushes in one embodiment of the present invention;

FIG. 2 is a schematic view showing a composition of a graphite brush;

FIG. 3 is a flow chart showing a process of manufacturing the graphite brush;

FIG. 4 is a flow chart of infiltrating the graphite brush with ethylene glycol;

FIG. 5 is a graph showing the vapor pressure of water;

FIG. 6 is a graph showing the vapor pressure of glycerin;

FIG. 7 is a graph showing the vapor pressures of glycols and glycol ethers;

FIG. 8 is a graph showing a relationship between the operating temperature of the graphite brush and the amount of abrasive wear in Embodiment 1;

FIG. 9 is a graph showing a relationship between the operating temperature of the graphite brush and the amount of abrasive wear in Embodiment 2;

FIG. 10 is a graph showing a relationship between the operating temperature of the graphite brush and the amount of abrasive wear in a comparative example;

FIG. 11 is a graph showing the vapor pressures of glycol ethers in Embodiment 3;

FIG. 12 is a graph showing a relationship between the operating temperature of the graphite brush and the amount of abrasive wear in Embodiment 3;

FIG. 13 is a graph showing the vapor pressures of glycol ethers in Embodiment 4;

FIG. 14 is a graph showing a relationship between the operating temperature of the graphite brush and the amount of abrasive wear in Embodiment 4;

FIG. 15 is a graph showing the vapor pressures of glycol ethers in Embodiment 5;

FIG. 16 is a graph showing a relationship between the operating temperature of the graphite brush and the amount of abrasive wear in Embodiment 5;

FIG. 17 is a graph showing the vapor pressures of glycol ethers in Embodiment 6;

FIG. 18 is a graph showing a relationship between the operating temperature of the graphite brush and the amount of abrasive wear in Embodiment 6;

FIG. 19 is a graph showing the vapor pressures of glycol ethers in Embodiment 7; and

FIG. 20 is a graph showing a relationship between the operating temperature of the graphite brush and the amount of abrasive wear in Embodiment 7.

### BEST MODE FOR CARRYING OUT THE INVENTION

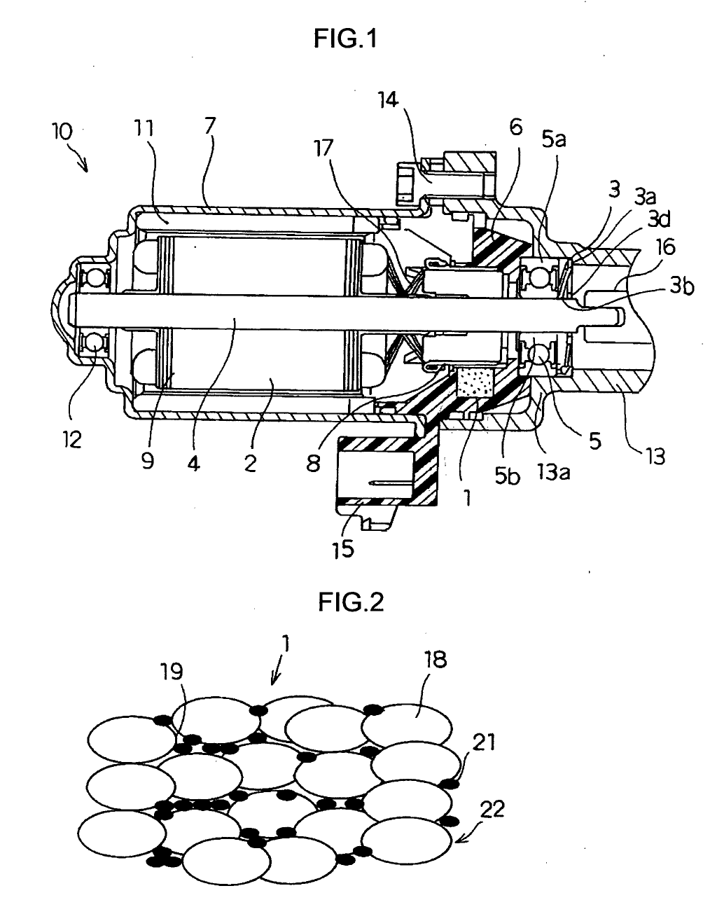

An embodiment of this invention will be described hereinafter with reference to the drawings. FIG. 1 is a sectional view showing a motor 10 using a graphite brush (hereinafter referred to simply as a brush) 1 for supplying electricity to a rotor 2. First, the configuration of the motor 10 will be described briefly with reference to FIG. 1.

The motor 10 shown in FIG. 1 has the rotor 2, which is rotatably supported to a housing 7 that is cylindrical in shape and is made of metal. The housing 7 is fixed to a housing 13 by fastening members 14 such as bolts and thus is integrated into a unit with the housing 13. The rotor 2 is supported by a shaft 4. The shaft 4 has two parallel planes at one end thereof (i.e. right-hand side in FIG. 1). A driven shaft 16 of a driven device is fitted onto the two parallel planes in an axial direction. Thus the shaft 4 is connected to the driven shaft 16, so that the rotation of the motor 10 may be transmitted to the exterior of the motor through the driven shaft 16.

The rotor 2 has a plurality of metal sheets layered in the axial direction to form a core 9, and the shaft 4 is press-fit in the center of core 9 to be integral therewith so that the rotor 2 and the shaft 4 are rotatable together. The other end of the shaft 4 is pressed into an inner ring of a bearing (i.e. first bearing) 12 that is press-fit into an end position of the housing 7, to be rotatably supported by the housing 7 through the bearing 12. On the other hand, the cylindrical housing 7 has a plurality of arcuate magnets 11 bonded to the inner surface thereof by an adhesive, or the like, in a peripheral direction.

The housing 13 to which housing 7 is attached has a recess 13a formed in a motor mounting surface where the rotor 2 is attached. An outer ring 5a of a bearing 5 is press-fit into this recess 13a, and the shaft 4 is supported through the bearing 5. Thus, the shaft 4 supporting the rotor 2 is rotatably supported at two end positions thereof by the two bearings 5 and 12. In this case, the other end of the shaft 4 opposite from where the bearing 12 is press-fit is pressed into an inner ring 5b of the bearing 5. The outer ring 5a of the bearing 5 is pressed into the recess 13a formed in the housing 13 so as to be in contact with the radially inner surface of the recess 13a. Within the housing 13, a spring 3 is mounted between the housing 13 of motor 10 and the bearing 5.

The spring 3 is formed from a disk-shaped metal plate with high elasticity (i.e. high spring constant) and has a hole 3d formed centrally thereof for receiving the shaft 4 therethrough. The spring 3 defines three slits arranged at 120 degrees apart from each other, and extending radially. The disk-shaped plate is bent three-dimensionally in the axial direction so as to form biasing portions 3b continuously from a support portion 3a. The support portion 3a of the spring 3 circumferentially contacts and engages a stepped portion of the recess 13a, and the biasing portions 3b contact a side of the outer ring 5a of the bearing 5 and biases the bearing 5 in an axial direction (i.e. leftward in FIG. 1).

On the other hand, a holder 6 is disposed on the rotor side of the bearing 5. The holder 6 is formed of resin, and is disposed coaxially with the housing 7. Electricity is supplied from the commutator 8 to a coil 17 wound on the core 9 of the rotor, and the holder 6 has two brushes 1 (only one is shown in FIG. 1) for contacting the commutator 8. The holder 6 has a connector 15 formed integrally therewith for supplying electricity from the exterior to the rotor through the brushes 1. By connecting an external connector (not shown) to this connector 15, electricity can be supplied through the brushes 13 to the coil 17 wound on the core 9 of the rotor 2. When electricity is supplied to the coil 17, the rotor 2 is rotated by the attractive and repulsive electromagnetic forces between the rotor 2 and the magnets 11.

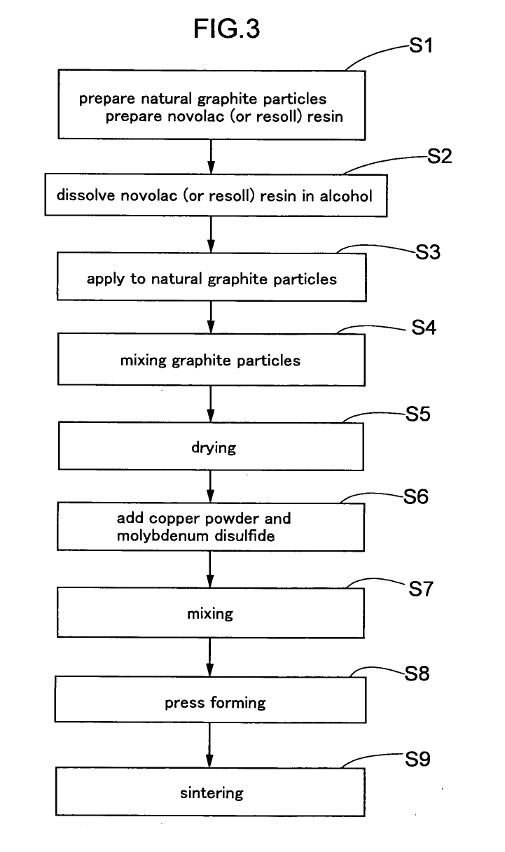

The brushes 1 in the motor 10 configured and operated as described above will be described in detail hereinafter. As shown in the schematic view of FIG. 2, each brush 1 in this embodiment is formed of a sintered compact 22 having natural graphite particles 18 as the base material. The sintered compact 22 has numerous porosities 19 at or on its surface and in its interior. First, an example of a manufacturing process for the sintered compact 22 to be used as the brush 1 will be described with reference to FIG. 3.

To manufacture the brush 1, natural graphite particles whose diameters are between 5 micrometers and 50 micrometers, and 2 to 3% by weight with respect to the graphite particles (S1) of novolac type (or resoll type) phenol resin of granular pellets are prepared. The phenol resin of novolac type (or resoll type) is dissolved in alcohol to make a dissolved phenol resin solution (S2). The alcohol solvent used here may be methyl alcohol, for example. In this case, instead of using alcohol for dissolving the above phenol resin, a ketone (e.g. acetone) may be used. That is, when dissolving in alcohol in S2, the thickness of the film of the phenol resin, formed on the surfaces of the graphite particles is determined by the viscosity of the dissolved phenol resin, added to the graphite particles 18. Then, the dissolved resin having the phenol resin, dissolved in alcohol is sprayed over the natural graphite particles 18 (S3). In the spraying step (S3), the dissolved resin is sprayed to obtain a uniform film of dissolved resin on the surfaces of graphite particles 18.

The graphite particles with the dissolved resin, applied to the surfaces are mixed (S4). In this mixing step, the graphite particles 18 are uniformly mixed by a mixing apparatus for a predetermined period of time (e.g. about 3 to 5 hours). The graphite particles are then dried in the atmosphere for about 30 minutes (S5).

The graphite particles (i.e. graphite granulation particles) obtained by the drying process are blended with copper powder depending on the amount of applied current to the brush 1 in order to restrict the amount of applied current to the brush 1 during the operation of the motor to be within a predetermined current density (S6). At the same time, in order to improve its sliding property with the commutator 8, it is desirable to add a solid lubricant such as molybdenum disulfide also. Through this process, copper powder and molybdenum disulfide are uniformly mixed (S7). Then, pressing (e.g. press forming) is performed with a pressing device (S8), to form a brush 1 of a desired shape. The formed product is sintered in nitrogen-rich atmosphere at a temperature between 700 and 800° C. for 2 to 3 hours (S9), to obtain the sintered compact 22 having the shape of a brush. On the surface and in the interior of the sintered compact 22 obtained in this manner, numerous porosities 19 are formed between adjoining graphite particles 18 as schematically shown in FIG. 2.

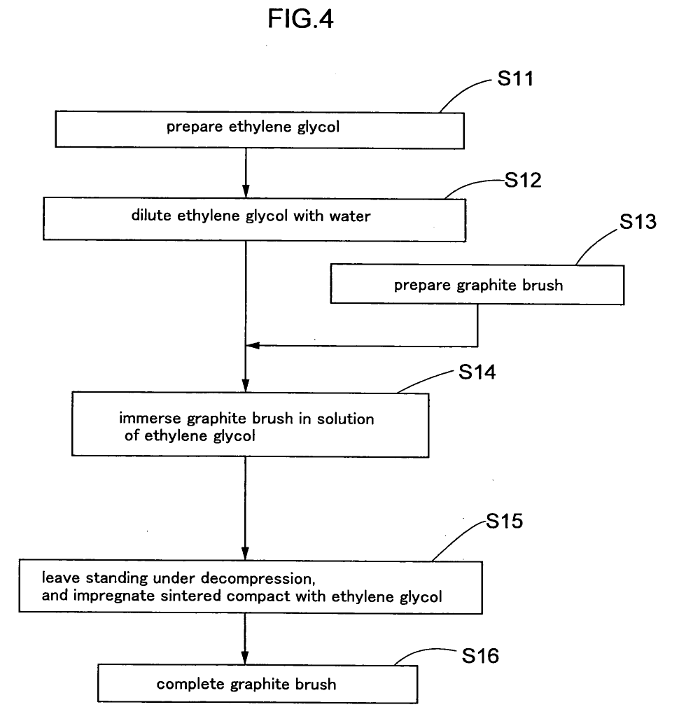

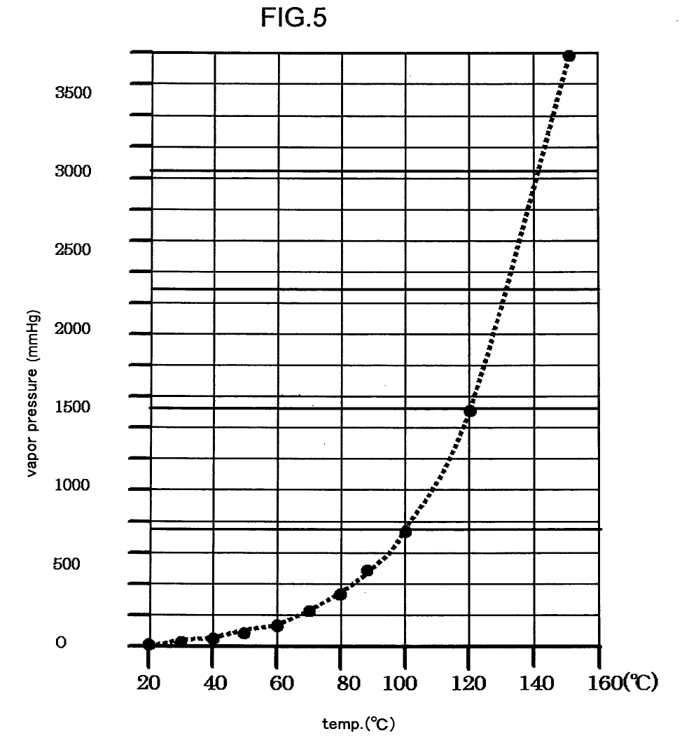

Next, an example of a process for infiltrating liquid 21 into the porosities 19 formed in the sintered compact 22, obtained through the process shown in FIG. 3 will be described with reference to FIG. 4.

The liquid 21 used for infiltrating the porosities 19 of the brush 1 is one that has a boiling point higher than the boiling point (i.e. 100° C.) of water. The liquid 21 is not limited to one kind, but may be a mixture of two or more kinds of liquids. Where the temperature of the slidable contacting surfaces of the brush 1 and commutator 8 reaches 100° C. or higher, it is desirable to have a liquid having a boiling point higher than the temperature near the slidable contacting surface of the brush 1. Therefore, it is particularly desirable to use alcohol, ether or the like as the liquid 21.

The boiling points will be described taking alcohols for example. With monohydric alcohols, the boiling point increases with the increase in the number of carbon and hydrogen. Among monohydric alcohols, for example, the boiling temperature of butanol is 117.3° C. and the boiling temperature of pentanol is between 102.3 and 138.3° C. Within the pentanol family, 1-pentanol has the highest boiling point among eight isomers. With dihydric alcohols, the boiling point of ethylene glycol is 197.9° C. With trihydric alcohols, the boiling point of glycerin is 290° C. The boiling point of isopropyl benzene is 152.4° C. For example, where the brush 1 is used at a high working temperature of 150° C. or higher, it is desirable to use ethylene glycol, glycerin or the like as alcohol.

Now, a process for infiltrating the liquid 21 into the porosities 19 of the sintered compact 22 will be described, taking ethylene glycol for example. In this process, ethylene glycol is prepared first (S11). Next, the ethylene glycol liquid is diluted with water depending on the ratio of the porosities formed in the sintered material 22 to the entire sintered compact (i.e. the ratio of porosity), or the size of porosities 19 (S12). The dilution is carried out, after making adjustment so that the diluted solution may have a predetermined surface tension, in order to facilitate the infiltration of the alcohol into the porosities. Instead of water, for example, ethanol may be used.

Next, sintered compact 22 is prepared which is to become it by sintering (S13), and is immersed in the solution of ethylene glycol (S14). The sintered compact 22 is left immersed in a low pressure condition of about 133 Pa for a predetermined period of time (e.g. about 1 to 2 minutes) to remove atmospheric air from the porosities and release it out of the container, so that the air in the porosities is replaced by ethylene glycol, to infiltrate ethylene glycol into the porosities (S15). After replacing the atmospheric air containing moisture in the porosities 19 of the sintered compact 22 completely with the solution of ethylene glycol, the sintered compact 22 is reinstated under the normal pressure, thereby obtaining the graphite brush in accordance with the present invention with its porosities 19 on or at the surfaces and within the sintered compact 22 infiltrated with the solution of ethylene glycol (S16).

As described in the process above, the liquid 21 is infiltrated into the porosities 19 formed in the sintered compact 22 of the brush 1, to hold the liquid 21 having a higher boiling point (i.e. 100° C. or higher) than water in the porosities 19 formed inside the sintered compact 22. Thus, the atmospheric air in the porosities 19 of the sintered compact is replaced by the liquid 21 having a higher boiling point than water. The above process has been described, using the case of infiltrating with one kind of liquid 21 as an example. Even where the liquid 21 is a mixture of two or more kinds of liquids, the infiltration can be carried out through the same process. That is, the graphite brush 1 of the present invention can be made by preparing, in S11, a liquid 21 having two or more kinds of liquids blended in a predetermined ratio.

By using the graphite brush 1 of the present invention, during the operation of the motor (i.e. when the brush is in a state of sliding contact), the presence of the liquid 21 between the slidable contacting surfaces of the brush 1 and the commutator 8 can make the coefficient of sliding friction of the slidable contacting surface low. Even when the brush 1 is operated in conditions where the temperature of the brush 1 rises above 100° C., the liquid 21 will not vaporize completely if the temperature is lower than the boiling point of the liquid 21, and the liquid 21 present between the slidable contacting surfaces will not completely disappear. This can prevent an increase in the coefficient of sliding friction, which causes an increasing in the amount of abrasive wear of the brush 1, in the prior art. As a result, the longevity of motor 10 can be substantially extended.

Generally, when the temperature of a liquid having a boiling point reaches a temperature near the boiling point, the vapor pressure of the liquid will rise sharply, and the vapor pressure is equal to 1 atmospheric pressure at the boiling point. Therefore, the liquid 21, infiltrated into the porosities 19 of the brush 1 under a low pressure condition is not vaporized as a large quantity of vapor until the temperature of the porosities 19 near the slidable contacting surface of the brush 1 approaches a temperature near the boiling point of the liquid 21. When used at a temperature near the boiling point as noted above, the liquid 21 is dissipated in large quantities because of the high vapor pressure, and vapor cannot be supplied to the slidable contacting surface of the brush 1 over a long period of time.

On the other hand, with an increase in the number of electrically operated parts in cars, motors 10 are used also in engine-related elements and brake-related elements. Engine-related elements such as a water pump and a lubricating oil pump, in particular, require a much longer continuous operation time of the motor 10, compared with vehicle body-related elements such as an electric window system. The continuous operation time comes up to several hours. With the extended continuous operation of the motor 10, the mean temperature at the slidable contacting surface of the brush 1 may rise to a range between 150° C. and nearly 250° C. Regardless of the temperature at which the motor 10 is used, it is desirable that the liquid 21 is always present in the porosities on or at the slidable contacting surfaces of the brush 1.

When the motor 10 is used at 120° C., for example, by using the brush 1 infiltrated with ethylene glycol as described above, ethylene glycol vaporizes at 120° C. to be present between the slidable contacting surfaces, thereby reducing the coefficient of sliding friction.

When using under temperatures varying from the room temperature to about 150° C., by using the brush 1 infiltrated with an aqueous solution of ethylene glycol, ethylene glycol can vaporize at temperatures between 100° C. to 150° C. to be present between the slidable contacting surfaces as described above, and water will vaporize below 100° C. to be present between the slidable contacting surfaces, thereby reducing the coefficient of sliding friction. When using at temperatures of 200° C. or higher, the amount of wear of the brush 1 can be reduced by using a brush 1 infiltrated with liquid having a boiling point higher than 200° C. That is, since the temperature range for vaporization is determined by the kind of liquid 21, it is necessary to determine the kinds and number of liquids 21 for infiltrating the brush 1 on the basis of examining how the motor 1 is used.

With a conventional graphite brush 1, as noted above, while there is a limitation of the quantity of stored moisture that can be taken into graphite particles in the porosities 19 based on the hygroscopic property of the graphite particles, the consumption rate of water vapor varies according to the temperature of the slidably contacting portions of the brush 1. And when the motor 10 operates continuously, the supply of moisture to the graphite particles is suspended. Consequently, the stored moisture in the porosities 19 gradually decreases through the continuous operation of the motor 10. With further progress of the continuous operation of the motor 10, the stored moisture taken into the porosities 19 will cease to exist and the water vapor on the slidable contacting surfaces will also disappear, thus increasing the coefficient of sliding friction of the slidable contacting surfaces and promoting a rapid wear of the graphite brush 1. The rate of vaporization of the stored moisture in the porosities 19 is determined by the value of the vapor pressure of water.

The conventional graphite brush 1, when operated continuously for 100 hours, wears at a substantially constant rate when the mean temperature of the slidable contacting surface is up to 80° C., but the rate of wear begins to increase with the rise in the temperature above 80° C. This is believed to be caused by the fact that, as noted above, the stored moisture consumption per unit time increases at temperatures above 80° C., and the stored moisture in the porosities 19 has been exhausted within 100 hours of operation. That is, the higher the mean temperature of the slidable contacting surface of the graphite brush 1 becomes, the greater quantity of the stored moisture in the porosities 19 vaporizes from the slidable contacting surface. As a result, all of the stored moisture, required to reduce the amount of wear of the graphite brush 1 is depleted at a certain period of continuous operation time, and a subsequent operation advances wear of the graphite brush 1.

FIG. 5 shows temperature dependency of the vapor pressure of water having a boiling point of 100° C. The vapor pressure of water begins to rise sharply near the boiling point of 100° C. Above the boiling point, the increase of vapor pressure becomes more pronounced. For example, the increase of vapor pressure with a 20° C. temperature rise from 100° C. to 120° C. is substantially the same as the increase of vapor pressure with a 100° C. temperature rise from 0° C. to 100° C. The vapor pressure at 20° C., which is a temperature at which the brush 1 can be used with no problems is 18 mmHg. At 80° C., which is a temperature immediately before the rate of the wear begins to increase, as described above, the value of the vapor pressure indicates 355 mmHg. From this viewpoint, for the purpose of reducing the rate of wear, the vapor pressure value of liquid 21, infiltrated into the porosities 19 of the graphite brush 1 is desirable to lie in the range between 18 mmHg corresponding to 20° C. and 355 mmHg corresponding to 80° C. of the vapor pressure value of water. It is possible to select rightly the kind (or kinds) of liquid 21 by using these values in the temperature dependence of vapor pressure as a reference. When the vapor contributes to lubrication effect, the coefficient of sliding friction of the slidable contacting surface is reduced due to the presence of gas molecules between the slidable contacting surfaces, which produces the effect of reducing adhesive wear. Therefore, a greater molecular weight of the liquid, used as the medium of vapor lubrication effect results in a greater occupied ratio by gas molecules per volume at the slidable contacting surface, promoting the effect of vapor lubrication.

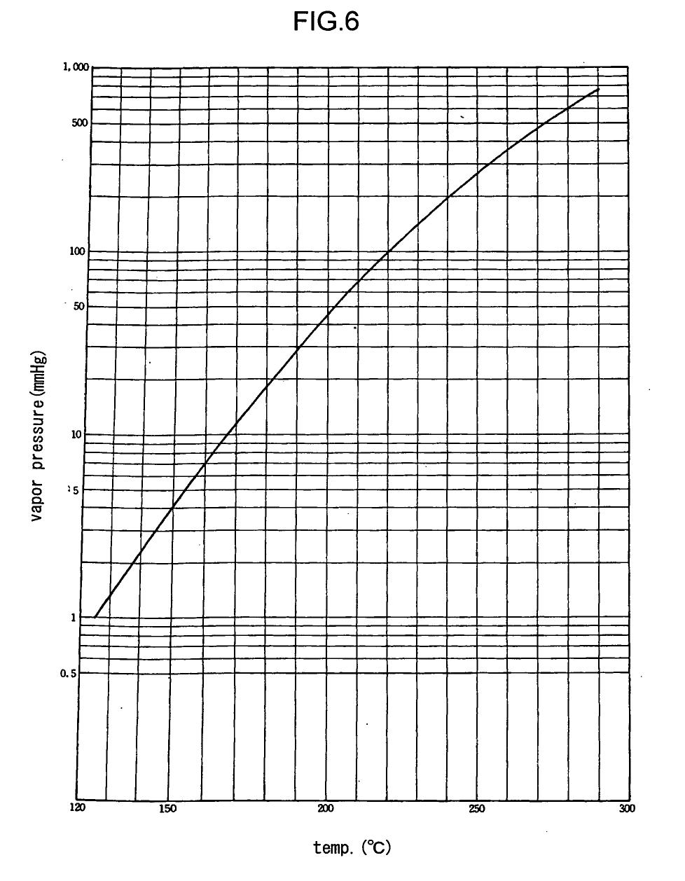

FIG. 6 shows, by way of an example, temperature dependency of the vapor pressure of glycerin having a boiling point of 290° C. It is near 180° C. that the vapor pressure value of glycerin indicates 18 mmHg, which is a vapor pressure value corresponding to that of water at 20° C., and near 260° C. that it indicates 355 mmHg, which is a vapor pressure value corresponding to that of water at 80° C. Then, when the motor 10 having brushes 1, infiltrated with glycerin is continuously operated at 200° C., for example, glycerin is vaporized from the porosities 19 to be present between the slidable contacting surfaces, which is desirable. When operated continuously at 120° C., although glycerin remains in the porosities 19, glycerin cannot vaporize sufficiently since the vapor pressure value is too low, probably increasing abrasive wear of the brush 1.

When the motor 10 is used over a wide temperature range, a liquid 21 that vaporizes at each temperature in the temperature range is needed. It is therefore desirable that the liquid 21 is a mixture of two or more kinds of liquids having a vapor pressure value in a range of 18 mmHg to 355 mmHg for each temperature. A mixing ratio may be determined as desired depending on how the motor 10 is used. Usually, the temperature of the slidable contacting surface of the brush 1 gradually increases with operation of the motor 10, and reaches a maximum temperature with a continuous operation. Subsequently, when the motor 10 is stopped, the temperature will drop. The temperature also goes up and down according to a repeatedly operation of the motor 10. Thus, the temperature of the slidable contacting surface of the brush 1 is at the lower temperature range more frequently. Therefore, as a desirable example of the mixing ratio, the mixture would include a greater quantity of liquid that vaporizes in a low temperature range, and a lower quantity of liquid that vaporizes in a high temperature range. As a result, the liquid 21 infiltrated into the limited volume in the porosities 19 of the brush 1 may be used efficiently as the medium of vapor lubrication effect over a long period of time.

It is desirable to use water as the liquid that vaporizes in the low temperature range up to 80° C. When the motor 10 having water as the liquid 21 operates, the water will preferentially vaporize from the aqueous solution of liquid 21 to be consumed as the temperature of the slidable contacting surface of the brush 1 increases. When the motor is stopped and the temperature of the slidable contacting surface of the brush 1 drops to near the room temperature, the brush 1 can take moisture in the atmosphere into the porosities 19 again for replenishment. Therefore, each ingredient forming the liquid 21, desirably, is soluble in water. It is also desirable that the liquid 21 is infiltrated as an aqueous solution.

On the other hand, the amount of liquid 21 that can be infiltrated into the porosities 19 of the brush 1 is limited due to the volume of the porosity of the brush 1. The porosity of the sintered compact 22 of the graphite brush 1 is approximately 20%. Since the temperature range where the motor 10 is most frequently used is between approximately 20° C. and approximately 80° C., water vapor is required to have a priority being present on the slidable contacting surface of the brush 1. However, where the motor 10 is used over a wide temperature range, because of the limited volume of the porosity, an increased ratio of water in the liquid 21 results in a possibility that the quantity of liquid 21 with high boiling point is insufficient. In such a case, therefore, at least one kind of liquid forming the liquid 21, desirably, has a hygroscopic property. With the liquid 21 including an ingredient having a hygroscopic property resulting in the water supply from the atmosphere, the quantity of water originally infiltrated into the porosities 19 of the sintered compact 22 of the brush 1 can be reduced or eliminated. Thus, it is possible to increase the amount of liquid 21 with high boiling points for infiltrating the porosities 19 of the brush 1.

One example of using a mixture of two or more kinds of liquids for the liquid 21 will be described. Where the operating temperature range of the motor 10 is between 20° C. and 250° C., it is desirable to divide the range into some temperature zones based on vapor pressure characteristics of liquid that provides the vapor in respective temperature range. How to divide it into the temperature zones can be determined on the basis of the analysis of the temperature characteristics of the vapor pressure of the liquid that provides the vapor for a given temperature zone.

The liquid provides the vapor in the temperature range between 20° C. and 80° C., desirably, is water. This is because, as noted above, moisture can be taken in from the atmosphere for replenishment, and the amount of water for the original infiltration can be reduced. For the temperature zone of 80° C. and higher, although there is no particular limitation in the liquid used since it can be determined as desired depending on how the motor 10 is used, one kind of liquid, desirably, is that which provides a vapor pressure value of 18 mmHg at temperatures below 80° C., and a vapor pressure value of 355 mmHg at temperatures above 80° C. A second kind of liquid, desirably, provides a vapor pressure value of 18 mmHg at temperatures below the temperature at which the vapor pressure value of the first kind of liquid corresponds 355 mmHg, and a vapor pressure value of 355 mmHg at higher temperatures. Where a third kind of liquid is mixed, it desirably shows similar vapor pressure characteristics to the second kind of liquid. The same is preferably true when mixing four or more kinds of liquids. By mixing such liquids, the vapor lubrication can be effected at all temperatures without a break in the temperature range from the room temperature to a predetermined temperature suited to the usage of the motor.

As for the ratio of the mixed liquids, a liquid that provides a vapor pressure of a low temperature zone, desirably, is mixed at an increased ratio since the motor is generally used more frequently at lower operating temperatures as noted above. The ratio of each liquid may be determined in accordance with how frequently the temperature range corresponding to the vapor pressures value of 18 mmHg to 355 mmHg of each liquid is kept.

There is no particular limitation in the liquids for making up the liquid 21, and any liquids having boiling points higher than the boiling point of water may be selected as desired. Where water is used as the medium of vapor lubrication at 80° C. and lower, liquids preferably have water solubility and hygroscopic properties. When two or more kinds of liquids are mixed, it is desirable that each dissolves smoothly with one another, and has vapor pressure characteristics in a predetermined temperature range. It is also preferred that each liquid does not thermally decompose in a operating temperature range of the motor 10, so that it vaporizes in the predetermined temperature range. As noted above, each liquid preferably has a large molecular weight in order to enhance the effect of vapor lubrication.

That is, preferred liquids for infiltrating the porosities 19 of the sintered compact 22 of the graphite brush 1 (1) have vapor pressure value between 18 mmHg and 355 mmHg in a predetermined temperature range, (2) have at least one kind of liquid having a hygroscopic property, (3) are soluble in water, (4) dissolves smoothly with one another, (5) are resistant to thermal decomposition at a predetermined temperature, and (6) have a relatively large molecular weight. From the above viewpoint, liquids suited for forming the liquid 21 include water-soluble glycols, water-soluble glycol ethers and glycerin, which are inexpensive and very safe.

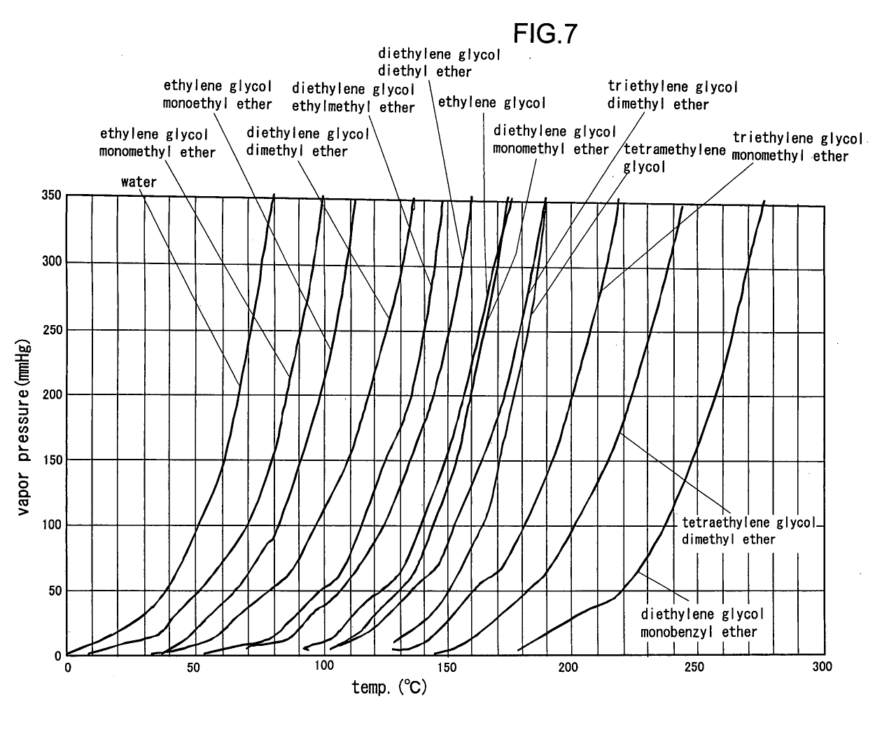

Tables 1-5 show molecular weights, vapor pressures, hygroscopic property and thermal decomposition property, respectively, of water-soluble glycols and water-soluble glycol ethers having boiling points in five temperature zones of 100-150° C., 150-200° C., 200-240° C., 240-280° C. and 280-330° C. In particular, (1) esters, (2) those having propylene oxide chains, and (3) those having relatively long alkyl chains at ends, seem undesirable since they easily undergo thermal decomposition. Glycols and glycol ethers that do not thermally decompose at least at 250° C. are selected, and their vapor pressure characteristics are shown in FIG. 7. Based on these vapor pressure characteristics, it is possible to select and combine glycols and glycol ethers that can effect vapor lubrication at predetermined temperatures.

### Table 1

### Table 2

### Table 3

### Table 4

### Table 5

### EMBODIMENTS

Embodiments of continuous operation tests using the motor 10 having graphite brushes 1 according to the present invention will be described hereinafter. In the operation tests, the graphite brushes 1 used had a size of 4.5 mm×9.0 mm, and abrasive wear of the graphite brushes 1 was examined after carrying out a continuous operation at a constant temperature, with the load of the graphite brushes 1 acting on the commutator 8 set to 78.5 kPa, and the rotational speed set to 3.6 m/s. The tests were conducted assuming an actual usage, using graphite brushes 1 with 85% by weight and 30% by weight of electrolytic copper powder added, respectively. Generally, a greater blending ratio of copper powder will result in a greater amount of abrasive wear of the graphite brushes 1.

### Embodiment 1

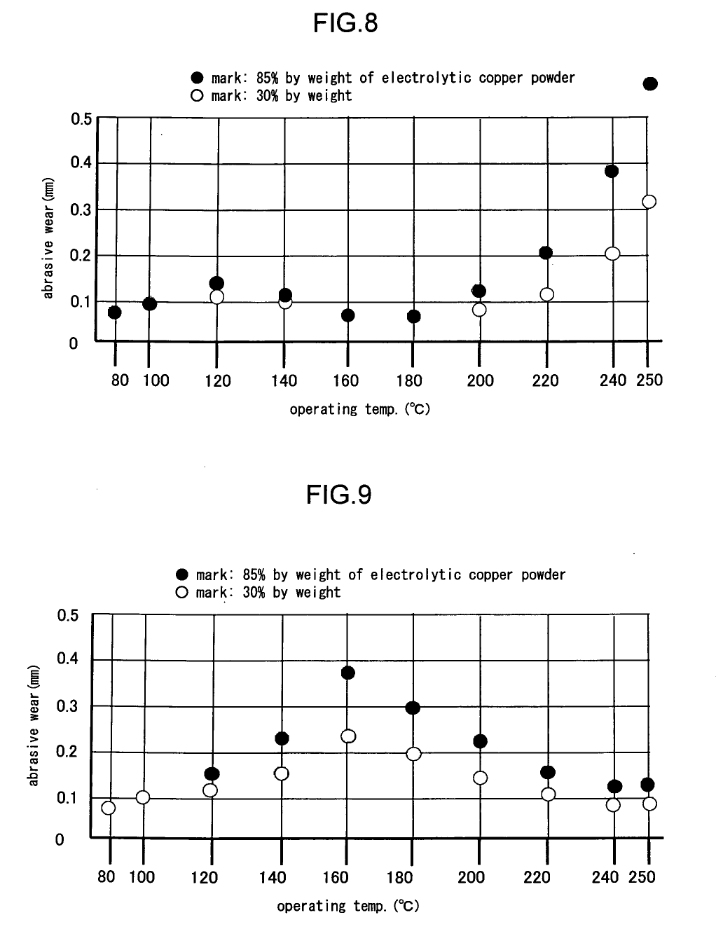

Continuous operation tests of the motor 10 were carried out using a graphite brush 1 infiltrated with ethylene glycol having a boiling point of about 198° C. as the liquid 21. With ethylene glycol, the temperature at which its vapor pressure reaches 18 mmHg is 105° C., and the temperature at which its vapor pressure reaches 355 mmHg is 175° C. As a result, as shown in FIG. 8, the amount of abrasive wear was low up to about 180° C., and at higher operating temperatures, the amount of abrasive wear increased with temperature. This is due to the effect of the moisture, taken in from the atmosphere up to approximately 100° C., and the effect of ethylene glycol up to approximately 180° C. Above 180° C., the vapor pressure of ethylene glycol increases further, and the time taken until exhaustion becomes short. Thus, as the operating temperature raised, the amount of abrasive wear of the graphite brush 1 increased. It is therefore desirable to use the motor 10 having the graphite brushes 1 infiltrated with ethylene glycol for temperatures up to approximately 180° C.

### Embodiment 2

Continuous operation tests of the motor 10 were carried out, as in Embodiment 1, using a graphite brush 1 infiltrated with glycerin having a boiling point of 290° C. as the liquid 21. With glycerin, the temperature at which its vapor pressure reaches 18 mmHg is 180° C., and the temperature at which its vapor pressure reaches 355 mmHg is 260° C. As a result, as shown in FIG. 9, the amount of abrasive wear was low, when the operating temperature of the graphite brush 1 was at 100° C. and below and was in the range between 200° C. and 250° C. On the other hand, the amount of abrasive wear increased at operating temperatures between a former mentioned two temperature ranges. The former is due to the effect of the moisture, taken in from the atmosphere up to approximately 100° C., as in Embodiment 1, and the latter is the effect of glycerin at the range between 200° C. and 250° C. However, at the intervening temperatures, the moisture has been already vaporized before 100 hours elapsed, and the temperatures are too low for glycerin to vaporize. When temperature increases in the range between 100° C. and 200° C., the moisture is depleted in a short time, thus the amount of abrasive wear increases. It is therefore desirable to use the motor 10 having the graphite brushes 1, infiltrated with glycerin for temperatures between 200 and 250° C.

### Comparative Example

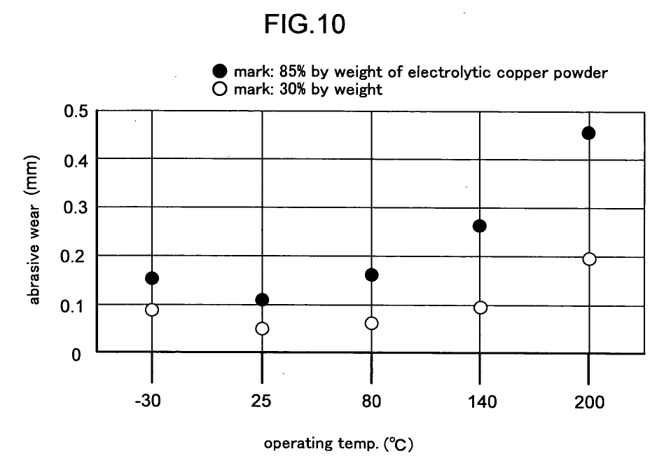

As a comparative example, continuous operation tests of the motor 10 were carried out in a similar manner but using a conventional graphite brush 1. The result is that, as shown in FIG. 10, the amount of abrasive wear of the graphite brushes 1 became large at slightly above 80° C., and became still larger at 100° C. and higher. This shows that it takes a shorter period of time for moisture to be depleted with an increase in the temperature as noted above.

### Embodiment 3

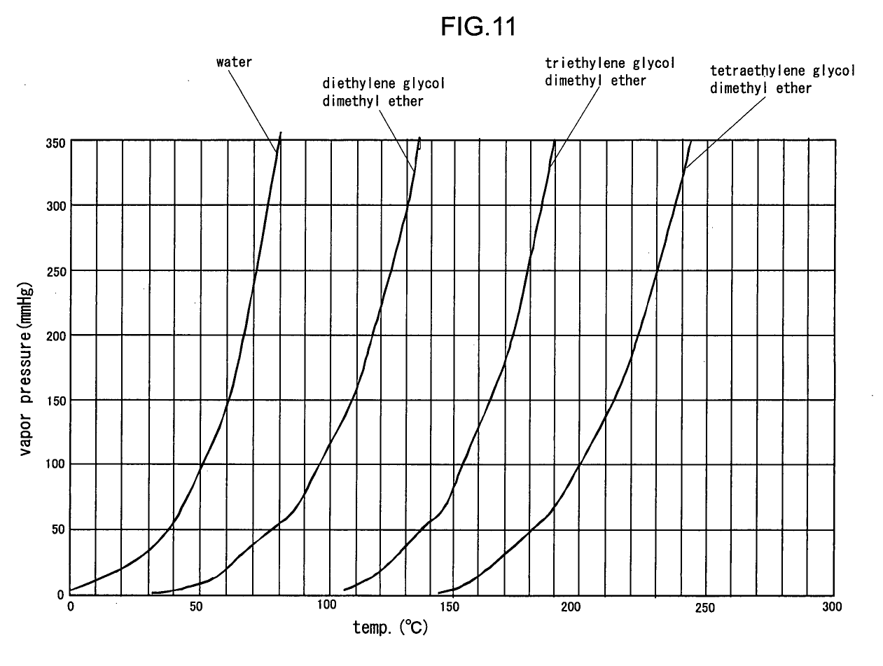

Graphite brushes 1 were infiltrated with a mixture of three kinds of glycol ethers, having vapor pressure characteristics shown in FIG. 11 as the liquid 21. With diethylene glycol dimethyl ether, the temperature range at which its vapor pressure indicates from 18 mmHg to 355 mmHg corresponds to the temperature range approximately 55° C. to approximately 135° C. It is a kind of the most thermally stable glycol ethers, because it has a methyl group at both ends of the structure, and is a diether, not an ester. Further, it has a hygroscopic property, and its molecular weight is 134.17, which is about 50 percent greater than the molecular weight 92.09 of glycerin.

With triethylene glycol dimethyl ether, the temperature range at which its vapor pressure indicates from 18 mmHg to 355 mmHg corresponds to the temperature range approximately 115° C. to approximately 190° C. It is a kind of the most thermally stable glycol ethers, because it has a methyl group at both ends of the structure and is one kind of triether, not an ester. Further, it has a hygroscopic property as ethylene glycol dimethyl ether does, and its molecular weight is 178.22, which is about twice the molecular weight 92.09 of glycerin.

With tetraethylene glycol dimethyl ether, the temperature range at which its vapor pressure indicates from 18 mmHg to 355 mmHg corresponds to the temperature range approximately 155° C. to approximately 250° C. It has a methyl group at both ends of the structure and is not a monoether but a tetraether. Therefore, it is a kind of the most thermally stable glycol ethers. It has a hygroscopic property. Further, its molecular weight is 222.28, which is about 2.4 times the molecular weight 92.09 of glycerin.

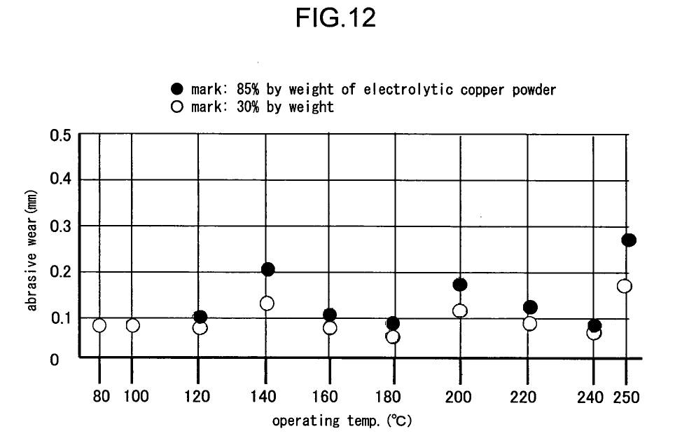

The liquid 21 was prepared by mixing the above three kinds of liquids in a volume ratio of 60%, 30% and 10%. Each liquid dissolved smoothly into each other, and was uniformly mixable. The graphite brushes 1 could be infiltrated as with the case of one kind of liquid. Continuous operation tests of the motor 10 were carried out, as in Embodiments 1 and 2, using such graphite brushes 1. The result was that, as shown in FIG. 12, the amount of abrasive wear could be maintained at a low level over wide temperature ranges. The characteristics of abrasive wear at each temperature reflects the temperature dependence of the vapor pressure of each liquid. While the main medium of vapor lubrication effect shifts from diethylene glycol dimethyl ether to triethylene glycol dimethyl ether at near 140° C., abrasive wear is once at a higher level since the vapor pressure of triethylene glycol dimethyl ether at near 140° C. is not sufficient, and therefore a sufficient amount of vapor of the liquid 21 cannot be supplied between the slidable contacting surfaces. At temperatures above 140° C., the amount of abrasive wear becomes less since the vapor pressure of triethylene glycol dimethyl ether becomes gradually large. Similarly, at temperatures near 200° C. the amount of abrasive wear of the brush is at a higher level since the main medium of vapor lubrication effect shifts from triethylene glycol dimethyl ether to tetraethylene glycol dimethyl ether. Further because the amount of abrasive wear increases gradually at 240° C. and higher, the higher the vapor pressure of tetraethylene glycol dimethyl ether rises, the less time the vapor is depleted.

### Embodiment 4

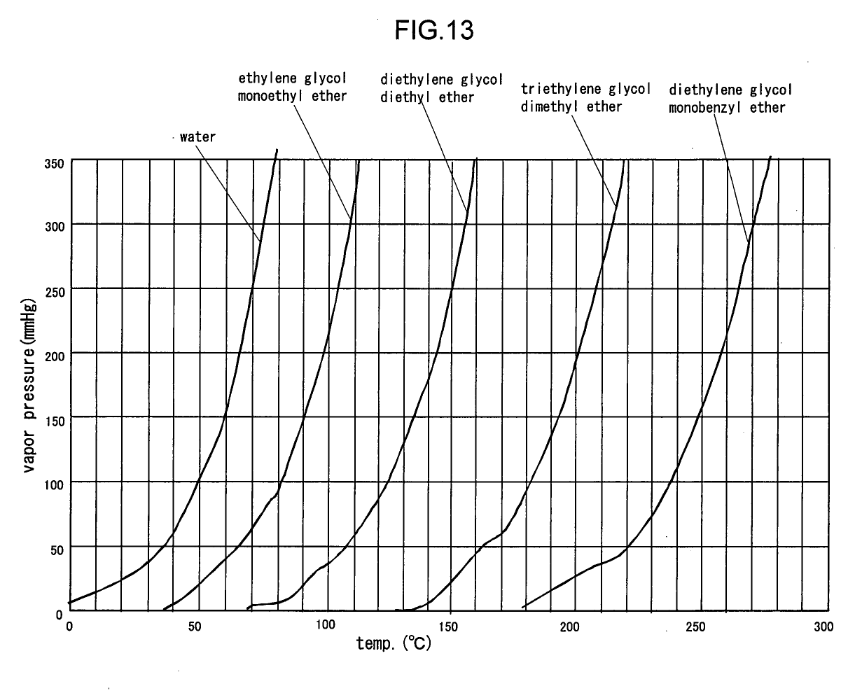

The graphite brush 1 was infiltrated with a mixture of four kinds of glycol ethers, having vapor pressure characteristics shown in FIG. 13 as the liquid 21. With ethylene glycol monoethyl ether, the temperature range at which its vapor pressure indicates from 18 mmHg to 355 mmHg corresponds to the temperature range approximately 45° C. to approximately 115° C. It has a hydroxyl group at both ends of the structure. Although its thermal stability is lower than that of the glycol ethers used in Embodiment 3, its boiling point is 134.8° C., i.e. a low boiling substance among glycol ethers. Further, its molecular weight is 90.12, which is about the same molecular weight as the molecular weight 92.09 of glycerin.

With diethylene glycol diethyl ether, the temperature range at which its vapor pressure indicates from 18 mmHg to 355 mmHg corresponds to the temperature range approximately 95° C. to approximately 160° C. Since it has an ethyl group at both ends of the structure and is one kind of diethers, not an ester, it is a kind of the most thermally stable glycol ethers. Further, it has a hygroscopic property, and its molecular weight is 162.23, which is nearly 1.8 times the molecular weight 92.09 of glycerin.

With triethylene glycol monomethyl ether, the temperature range at which its vapor pressure indicates from 18 mmHg to 355 mmHg corresponds to the temperature range approximately 145° C. to approximately 220° C. It has a hydroxyl group at one end of the structure, being a lower thermal stability group than an alkyl group having a short chain. However, since it has a methyl group at the other end of the structure and is a kind of thermally stable triethers, it is a kind of thermally stable glycol ethers. Further, its molecular weight is 164.21, which is nearly 1.8 times the molecular weight 92.09 of glycerin.

With diethylene glycol monobenzyl ether, the temperature range at which its vapor pressure indicates from 18 mmHg to 355 mmHg corresponds to the temperature range approximately 185° C. to approximately 280° C. Although its one end group is a hydroxyl group of the structure, it does not thermally decompose since it is a thermally stable diether. Further, its molecular weight is 196.24, which is about 2.1 times the molecular weight 92.09 of glycerin.

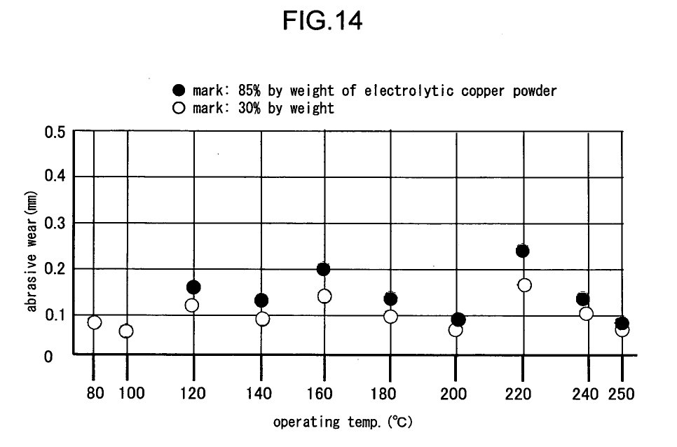

The liquid 21 was prepared by mixing the above four kinds of liquids in a volume ratio of 50%, 30%, 15% and 5%. Each liquid dissolved smoothly into one another, and was uniformly mixable. The graphite brush 1 could be infiltrated as with the case of one kind of liquid. Continuous operation tests of the motor 10 were carried out, as in Embodiments 1 and 2, using such graphite brush 1. The result was that, as shown in FIG. 14, the amount of abrasive wear could be maintained at a low level over wide temperature ranges. As in Embodiment 3, the amount of abrasive wear increases near the temperatures at which the main medium of vapor lubrication effect shifts to a different kind of liquid. That is, at near 120° C., the main medium of vapor lubrication effect shifted from ethylene glycol monoethyl ether to diethylene glycol diethyl ether. At near 160° C., it shifted from diethylene glycol diethyl ether to triethylene glycol monomethyl ether. At near 220° C., it shifted from triethylene glycol monomethyl ether to diethylene glycol monobenzyl ether. The reason why the amount of abrasive wear increased particularly at 220° C. is that diethylene glycol monobenzyl ether which vaporizes easily at higher temperatures than 220° C. was used in order to reduce the abrasive wear at 250° C. as compared with Embodiment 3.

This is a preferable arrangement because of the advantages that, with one additional kind of glycol ether as compared with Embodiment 3, (1) abrasive wear can be reduced even in a wide temperature zone above 250° C., and (2) temperature zones at which glycol ethers vaporize can be arranged to overlap one another in order that the vapors is supplied thoroughly over wide temperature ranges.

### Embodiment 5

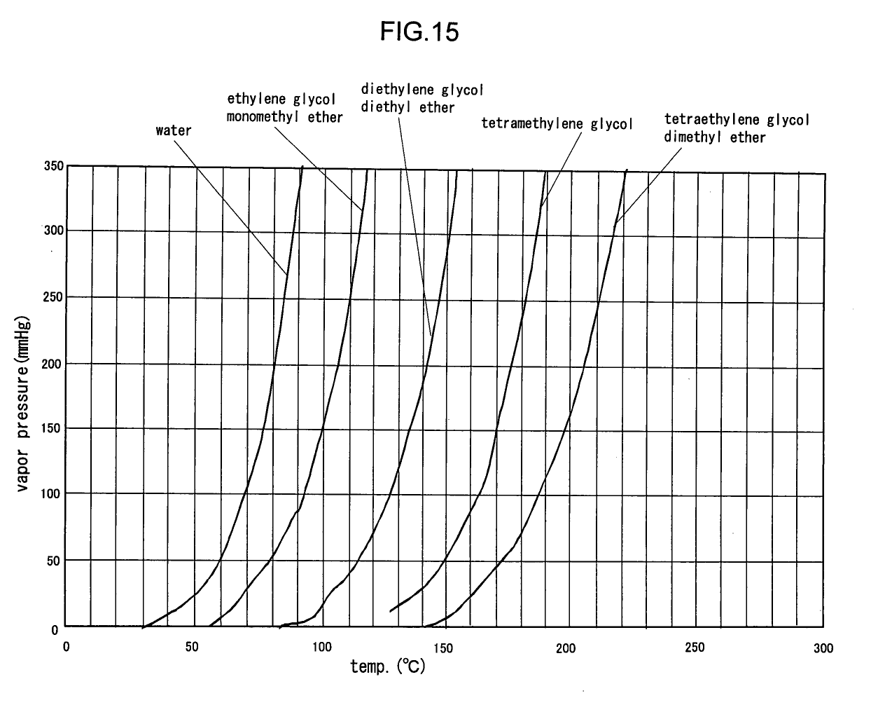

The graphite brush 1 was infiltrated with a mixture of four kinds of glycol ethers having vapor pressure characteristics shown in FIG. 15 as the liquid 21. Of the liquids 21 in Embodiment 4, triethylene glycol monomethyl ether was replaced with tetramethylene glycol, and diethylene glycol monobenzyl ether was replaced with tetraethylene glycol dimethyl ether. With tetramethylene glycol, the temperature range at which its vapor pressure indicates from 18 mmHg to 355 mmHg corresponds to the temperature range of approximately 132° C. to approximately 190° C. Where tetramethylene glycol coexists with an acid it is cyclized to provide tetrahydrofuran under a circumstance of high temperature. In the case of no acid, it is thermally stable even at 200° C. It has a hygroscopic property, and its molecular weight is 90.12, which is about the same as the molecular weight 92.09 of glycerin. Thus, tetraethylene glycol dimethyl ether was used in Embodiment 3.

By using the liquid 21 as described above, compared with Embodiment 4, this embodiment has the following two differences. (1) since the glycol ether, whose vapor pressure growing up to 18 mmHg at approximately 145° C. was replaced with the glycol ether, whose vapor pressure growing up to 18 mmHg at approximately 132° C., the vapor pressure of the liquid, served as the medium of vapor lubrication effect increased in the temperature range between 132 and 205° C. (2) Since the glycol ether, whose vapor pressure growing up to 18 mmHg at approximately 185° C. was replaced with the glycol ether, whose vapor pressure growing up to 18 mmHg at approximately 155° C., the vapor pressure of the liquid, served as the medium of vapor lubrication effect increased in the temperature range between 155° C. and 245° C., but then it decreased at 245° C. and higher.

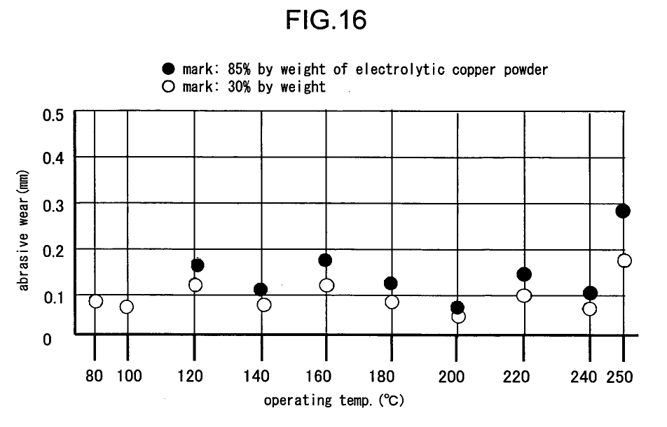

The liquid 21 was prepared by mixing the four kinds of liquids in a volume ratio of 50%, 30%, 15% and 5%. Each liquid dissolved smoothly into one another, and was uniformly mixable. The graphite brush 1 could be infiltrated as with the case of one kind of liquid. Continuous operation tests of the motor 10 were carried out, as in the other embodiments, using such graphite brush 1. The result was that, as shown in FIG. 16, the amount of abrasive wear could be maintained at a low level over wide temperature ranges. Amount of abrasive wear increased at each point, 120° C., 140° C., and 220° C. but was less than that in Embodiment 4. Since glycol ethers that vaporize at lower temperature ranges were used as the liquid 21, the amount of abrasive wear at 250° C. was greater.

### Embodiment 6

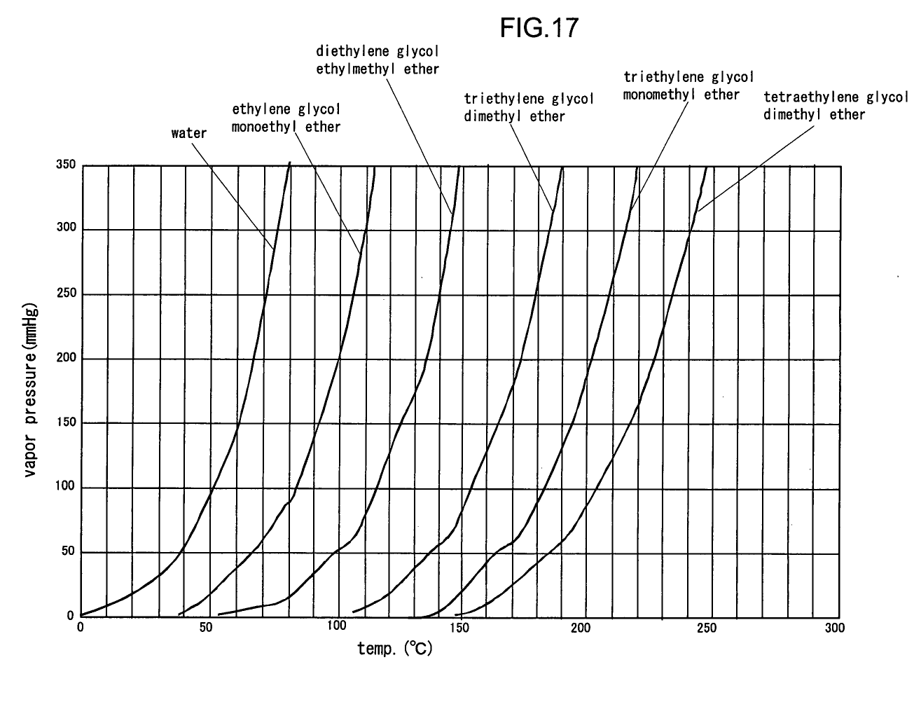

The graphite brush 1 was infiltrated with a mixture of five kinds of glycol ethers, having vapor pressure characteristics shown in FIG. 17 as liquid 21. Ethylene glycol monoethyl ether is used the same as in Embodiment 4. With diethylene glycol methyl ethyl ether, the temperature range at which its vapor pressure indicates from 18 mmHg to 355 mmHg corresponds to the temperature range of approximately 65° C. to approximately 115° C. Since it is combined with methyl group at one end group and with ethyl group at the other end group of the structure, which are alkyl groups having short chains, and it is a diether, not an ester, it is a kind of the most thermally stable glycol ethers. Further, it has a hygroscopic property, and its molecular weight is 148.21, which is 1.6 times the molecular weight 92.09 of glycerin. Triethylene glycol dimethyl ether is used in Embodiment 3, triethylene glycol monomethyl ether is used in Embodiment 4, and tetraethylene glycol dimethyl ether is used in Embodiment 3.

Since one more kind of glycol ether is used in Embodiment 6 compared with Embodiments 4 and 5, the temperature range that vapor of each glycol ether contributes is even narrower. Therefore each infiltrated quantity of those glycol ethers in the porosities of the graphite brush 1 is smaller than that in Embodiments 4 and 5. However, the amount of vapor of two kinds of glycol ethers that vaporize in the temperature zone between 110° C. and 190° C. in Embodiment 6 is greater compared with that in the same temperature zone in Embodiments 4 and 5. The vapor as the medium of vapor lubrication effect is able to be supplied thoroughly over the temperature zone by means that two or more kinds of glycol ethers vaporize overlapping one another.

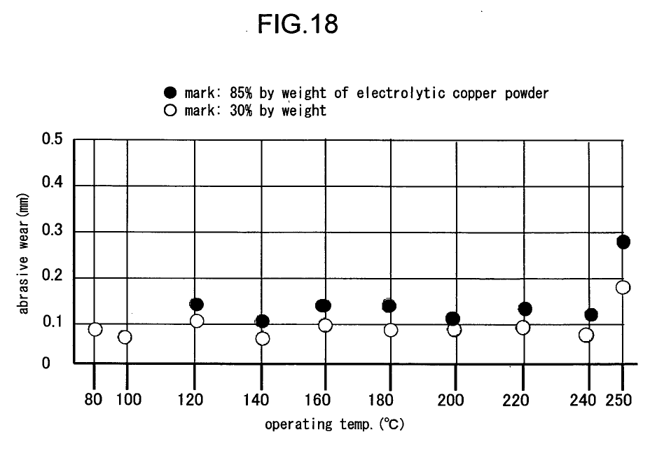

The liquid 21 was prepared by mixing the above five kinds of liquids in a volume ratio of 40%, 30%, 15%, 10% and 5%. Each liquid dissolved smoothly into one another, and was uniformly mixable. The graphite brush 1 could be infiltrated as with the case of one kind liquid. Continuous operation tests of the motor 10 were carried out, as in the other embodiments, using such graphite brush 1. The result was that, as shown in FIG. 18, the amount of abrasion wear was reduced to 0.2 mm or less in the temperature range up to 240° C. Since vapor, vaporized at each temperature is supplied more uniformly compared with Embodiments 3 and 4, the amount of abrasive wear did not increase very much even at the temperatures, at which the kinds of glycol ethers contributing as the main medium of vapor lubrication effect shifts.

### Embodiment 7

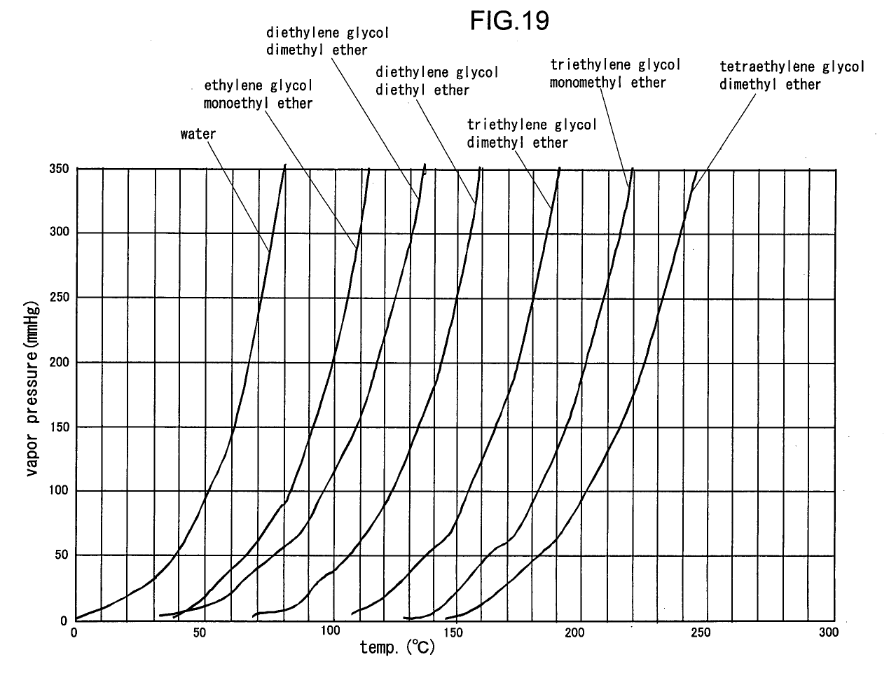

The graphite brush 1 was infiltrated with a mixture of six kinds of glycol ethers, having vapor pressure characteristics shown in FIG. 19 as liquid 21. The liquid is composed of ethylene glycol monoethyl ether used in Embodiment 6, diethylene glycol dimethyl ether used in Embodiment 3, diethylene glycol diethyl ether used in Embodiment 4, and triethylene glycol dimethyl ether, triethylene glycol monomethyl ether and tetraethylene glycol dimethyl ether used in Embodiment 6 respectively.

In Embodiment 7, the temperature range that the vapor of each glycol ether contributes is still narrower compared with that in Embodiment 6. Therefore, a mixing ratio of each glycol ether decreases. However, in the temperature range where the vapor pressure, growing up to 18 mmHg or greater is supplied by two or three kinds of different glycol ether, the total vapor pressure at each temperature in the temperature range is greater than that in Embodiment 6. Since different kinds of the glycol ethers, having different vapor pressure characteristics of temperature dependence contribute at each temperature as the medium of vapor lubrication effect, vapor can be vaporized uniformly over wide temperature ranges.

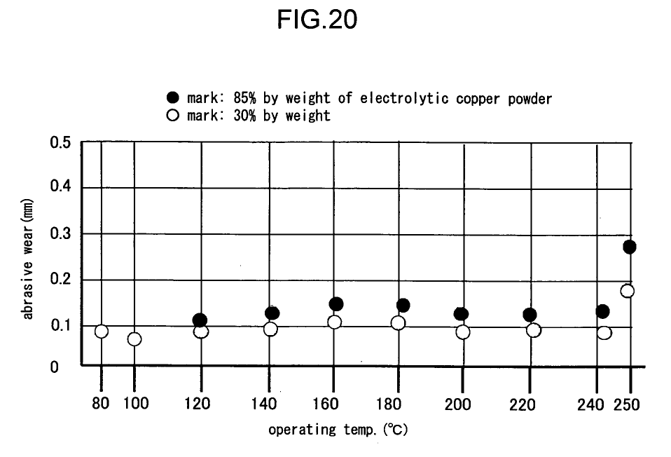

The liquid 21 was prepared by mixing the above six kinds of liquids in a volume ratio of 35%, 25%, 20%, 10%, 6% and 4%. Each liquid dissolved smoothly into one another, and was uniformly mixable. The graphite brushes 1 could be infiltrated as with the case of one kind liquid. Continuous operation tests of the motor 10 were carried out, as in the other embodiments, using such graphite brush 1. The result was that, as shown in FIG. 20, the amount of abrasion wear was reduced to 0.15 mm or less in the temperature range up to 240° C.

### INDUSTRIAL UTILITY

A motor having a graphite brush in accordance with the present invention may be used in vehicles as a motor for driving a water pump that cools an engine of the vehicle, a motor for turning a cooling fan, or a motor for driving an engine oil pump, and for various other purposes.

TABLE 1

| | molecular | vapor pressure (° C.) | | | hygroscopic | |
|---|---|---|---|---|---|---|
| compound | weight | 10 mmHg | 50 mmHg | 760 mmHg | property | thermal stability |
| propylene glycol monomethyl ether | 90.12 | 23.7 | 67 | 121.0 | yes | low due to propylene group |
| (1-methoxy-2-propanol) | | | | | | |
| ethylene glycol monomethyl ether | 76.1 | 27 | 56 | 124.5 | yes | slightly low due to hydroxyl group |
| (2-methoxyethanol) | | | | | | at end |
| propylene glycol monoethyl ether | 104.15 | 30.6 | 60 | 132.2 | yes | low due to propylene group |
| (1-ethoxy-2-propanol) | | | | | | |
| ethylene glycol monoethyl ether | 90.12 | 36 | 66 | 134.8 | yes | slightly low due to hydroxyl group |
| (2-ethoxyethanol) | | | | | | at end |
| ethylene glycol monoisopropyl ether | 104.15 | 44 | 74 | 141.8 | yes | low due to isopropyl group and |
| (2-isoproxy ethanol) | | | | | | hydroxyl group at end |
| ethylene glycol methyl ether acetate | 118.13 | 42 | 71 | 145.1 | yes | low due to ester |
| (2-methoxyethyl acetate) | | | | | | |
| propylene glycol monopropyl ether | 118.18 | 46 | 76 | 149.8 | yes | low due to propyl group and |
| | | | | | | hydroxyl group at end, propylene |
| | | | | | | group |

TABLE 2

| | molecular | vapor pressure (° C.) | | | hygroscopic | |
|---|---|---|---|---|---|---|
| compound | weight | 10 mmHg | 50 mmHg | 760 mmHg | property | thermal stability |
| ethylene glycol monoisobutyl ether | 118.18 | 53 | 85 | 160.5 | yes | low due to isobutyl group and |
| | | | | | | hydroxyl group at end |
| diethylene glycol dimethyl ether | 134.17 | 49.5 | 84.0 | 164.0 | yes | stable due to methyl group at both |
| | | | | | | ends and diether |
| ethylene glycol monobutyl ether | 118.18 | 62 | 94 | 171.2 | yes | low due to butyl group and hydroxyl |
| (2-butoxyethanol) | | | | | | group at end |
| diethylene glycol methyl ethyl ether | 148.21 | 64 | 98 | 176 | yes | stable due to methyl group and ethyl |
| | | | | | | group at end |
| dipropylene glycol monomethyl | 148.21 | 74.6 | 110 | 187.2 | yes | low due to hydroxyl group at end and |
| ether (1,2-propanol) | | | | | | propylene group |
| propylene glycol | 76.09 | 86 | 114 | 188.2 | yes | low due to hydroxyl group at end and |
| | | | | | | propylene group |
| diethylene glycol diethyl ether | 162.23 | 72.0 | 107.0 | 188.9 | yes | stable due to ethyl group at both ends |
| | | | | | | and diether |
| diethylene glycol monomethyl ether | 120.15 | 82 | 115 | 194.0 | yes | slightly low due to hydroxyl group at |
| (2-(2-methoxyethoxy) ethanol) | | | | | | end |
| hexylene glycol | 118.17 | 94 | 125 | 197.1 | yes | low due to hydroxyl group at both |
| (2-methyl-2,4-pentanediol) | | | | | | ends and hexyl group |
| dipropylene glycol monoethyl ether | 162.22 | 83 | 117 | 197.8 | yes | low due to hydroxyl group at end and |
| (1,2-propanol) | | | | | | propylene group |
| ethylene glycol | 62.07 | 93 | 124 | 197.85 | excessive | stable |

TABLE 3

| | molecular | vapor pressure (° C.) | | | hygroscopic | |
|---|---|---|---|---|---|---|
| compound | weight | 10 mmHg | 50 mmHg | 760 mmHg | property | thermal stability |
| diethylene glycol monoethyl ether | 134.17 | 88 | 123 | 201.9 | yes | slightly low due to hydroxyl group at |
| (2-(2-ethoxyethoxy) ethanol) | | | | | | end |
| | | | | | | Note: vapor pressure characteristics |
| | | | | | | are similar to EG. |
| 1,3-butylene glycol | 90.12 | 97 | 132 | 207.5 | yes | low due to hydroxyl group at both |
| (1,3-butanediol) | | | | | | ends |
| trimethylene glycol | 76.09 | 113 | 148 | 214 | yes | low due to hydroxyl group at both |
| (1,3-propanediol) | | | | | | ends |
| triethylene glycol | 178.22 | 95.0 | 130.0 | 216.0 | yes | stable due to methyl group at both |
| dimethyl ether | | | | | | ends |
| diethylene glycol ethyl ether acetate | 176.21 | 96 | 130 | 217.4 | yes | low due to esters |
| (2-ethoxyethoxyethyl acetate) | | | | | | |
| tetramethylene glycol | 90.12 | 122 | 154 | 229.2 | yes | slightly low due to hydroxyl groups |
| (1,4-butanediol) | | | | | | at both ends |
| diethylene glycol monoisobutyl ether | 162.23 | 98 | 134 | 220 | yes | low due to isobutyl group and |
| | | | | | | hydroxyl group at end |
| diethylene glycol monobutyl ether | 162.23 | 109 | 145 | 230.6 | yes | low due to butyl group and hydroxyl |
| (2-(2-butoxyethoxy) ethanol) | | | | | | group at end |
| dipropylene glycol | 134.17 | 114 | 151 | 231.8 | slightly | low due to hydroxyl group at both |
| | | | | | | ends and propylene group |

TABLE 4

| | molecular | vapor pressure (° C.) | | | hygroscopic | |
|---|---|---|---|---|---|---|
| compound | weight | 10 mmHg | 50 mmHg | 760 mmHg | property | thermal stability |
| tripropylene glycol monomethyl ether | 206.3 | 118 | 156 | 242.3 | yes | low due to hydroxyl group at end and |
| | | | | | | propylene group |
| pentamethylene glycol | 104.15 | 134 | 160 | 242.4 | yes | low due to hydroxyl group at both |
| (1,5-pentanediol) | | | | | | ends |
| diethylene glycol | 106.12 | 130 | 165 | 244.33 | yes | low due to hydroxyl group at both |
| | | | | | | ends |
| triethylene glycol monomethyl ether | 164.21 | 122 | 160 | 249.0 | yes | slightly low due to hydroxyl group at |
| | | | | | | end |
| diethylene glycol monohexyl ether | 190.29 | 132 | 170 | 259.1 | slightly | low due to hexyl group and hydroxyl |
| | | | | | | group at end |
| triethylene glycol monobutyl ether | 206.29 | 148 | 188 | 271.2 | yes | low due to butyl group and hydroxyl |
| | | | | | | group at end |
| triethylene glycol | 150.17 | 162 | 198 | 278.31 | yes | low due to hydroxyl group at both |
| | | | | | | ends |
| tetraethylene glycol dimethyl ether | 222.28 | 144.2 | 183.1 | 275 | yes | stable due to methyl group at both |
| | | | | | | ends |

TABLE 5

| | molecular | vapor pressure (° C.) | | | hygroscopic | |
|---|---|---|---|---|---|---|
| compound | weight | 10 mmHg | 50 mmHg | 760 mmHg | property | thermal stability |
| diethylene glycol monobenzyl ether | 196.24 | 185 | 220 | 302.0 | yes | slightly low due to hydroxyl group |
| | | | | | | at end |
| tetraethylene glycol | 194.23 | 188 | 232 | 327.3 | yes | low due to hydroxyl group at both |
| | | | | | | ends |

1. A graphite brush for supplying electricity to a coil wound around a core provided to a rotor of a motor,
wherein the graphite brush is made of sintered compact having porosities at a surface of and inside the sintered compact, said porosities being infiltrated with a liquid having a higher boiling point than the boiling point of water.

2. A graphite brush as defined in claim 1, wherein said liquid comprises a mixture of plural kinds of liquids having different boiling points.

3. A graphite brush as defined in claim 1, wherein said liquid comprises at least one kind of liquid selected from water-soluble glycols, water-soluble glycol ethers, and glycerin.

4. A graphite brush as defined in claim 1, wherein said liquid comprises at least one kind of liquid selected from water-soluble glycols having hygroscopic properties, and water-soluble glycol ethers having hygroscopic properties.

5. A graphite brush as defined in claim 1, wherein said liquid comprises at least one kind of liquid having a boiling point higher than a maximum temperature of a slidable contacting surface of said graphite brush and a commutator forming part of said motor.

6. A graphite brush as defined in any one of claims 2 to 5, wherein said mixture has a greater mixing ratio for said liquid having a lower boiling point.

7. A motor comprising:
a housing;
magnets arranged in the housing;
a rotor rotatably provided in the housing so as to face the magnets, and having a coil wounded around a core of the rotor;
a shaft for supporting the rotor to said housings;
a commutator provided on said rotor for supplying electricity to said coil; and
a graphite brush in sliding contact with the commutator;
wherein said graphite brush is made of sintered compact having porosities at a surface of and inside the sintered compact, said porosities being infiltrated with a liquid having a higher boiling point than the boiling point of water.
